(19) United States
(12) Patent Application Publication
(10) Pub. No.: US 2008/0139228 A1
(43) Pub. Date: Jun. 12, 2008

(54) Text-based initiated call bridging

(75) Inventors: Daniel Joseph Raffel, San Francisco, CA (US); Pramod Khincha, San Jose, CA (US); Anil Kumar, Campbell, CA (US)

Correspondence Address: MPG, LLP AND YAHOO! INC., 710 LAKEWAY DRIVE, SUITE 200, SUNNYVALE, CA, 94085, US

(73) Assignee: Yahoo, Inc, Sunnyvale, CA (US)

(21) Appl. No.: 11/635,459

(22) Filed: Dec. 6, 2006

(51) Int. Cl. H04Q 7/20

(52) U.S. Cl. 455/466

(57) ABSTRACT

A computer implemented method for establishing a phone call between parties is provided. The method includes receiving a text message at a server. Then, processing the text message at the server to identify a type of call requested in the text message and the parties to connect. Two or more internet-based calls are initiated from the server so as to establish phone connections to each of the parties. The method then includes bridging the phone connections to establish the phone call between the parties. The phone call is thus setup in response to the content of the text message, and the phone call is configured in a manner that reduces cost to the phone call requesting text sender. The text message may dictate whether the call is to be between two or more parties, and in some examples, the text message can identify when the call should take place, thus providing advanced scheduling options, at which time the call will automatically be set up.

### BACKGROUND OF THE INVENTION

1. Field of the Invention

This invention relates generally to the interactive set up of phone calls, and more particularly, to the set up of phone calls in response to text message processing.

2. Description of the Related Art

Telephone communication has been around for quite some time. Over the years, the technology supporting telephone communication has matured, and in common day systems, a majority of such technology has entered the digital age. With the advent of more sophisticated telephony technology, companies have introduced numerous features and functionality to receive calls, place calls, transfer calls, conduct conferencing, handle voicemail, etc. among many other features. Added to this technology, mobile communication has also experienced substantial growth, and many of the features found on standard landlines are also possible on mobile phones.

Although number of features has continued to grow and the technology associated with traditional phone systems has seen a convergence between mobile and Internet phone systems, the standard method for placing a call has remained quite the same. If a person wishes to establish a phone call, the person will pick up the receiver (or turn on the phone) and then dial the phone number assigned to the intended recipient of the call. Once the number is dialed, the call is processed by the phone company provider that initially activated the service for the landline phone or mobile phone. In a similar manner, users of Internet soft-phone technologies also must go to a website, input the phone number or select a phone number from a list, and then request connection by selecting a dial button.

Once the dial button is pressed or number is dialed, the phone carriers will move your phone call connection request through their systems, negotiate connections through international systems (e.g., for international calls), and then initiate the phone call. The charges established by the phone companies, depending on the many available and ever changing plans, are then applied to the phone bills of the dialing person. In essence, the dialer is at the will of the phone companies and rates will be charged without providing the caller with additional options.

Further yet, when a call is dialed, the call must happen at that time it is dialed. With traditional services, there is commonly no way of setting up a call that will happen at a later point in time or between persons other than the dialing person. To achieve this functionality, users are required to call operators that will, for a charge, set up the calls.

In view of the foregoing, there is a need for added flexibility in the way phone calls are set up and the way phone calls are scheduled. There is also a need for telephony technology that will provide users with the freedom of selecting the connection system and methods used to make calls, whether local or international, and to provide users with better understanding of costs involved in the call set up and process.

### SUMMARY OF THE INVENTION

Broadly speaking, the present invention fills these needs by providing methods and computer driven operations for enabling the setup and connection of phone calls, in response to receipt and processing of a text message. In an example, the text message is sent through one or more servers to a call bridging server is configured to setup and make calls to the parties of the phone call, and when connections with the parties are established, the gateway server is configured to bridge the calls to define the desired call, as requested in the text message. It should be appreciated that the present invention can be implemented in numerous ways, including as a method, a system, or a device. Several inventive embodiments of the present invention are described below.

In accordance with one embodiment, a computer implemented method for establishing a phone call between parties is defined. The method includes receiving a text message at a server. Then, processing the text message at the server to identify a type of call requested in the text message and the parties to connect. Two or more internet-based calls are initiated from the server so as to establish phone connections to each of the parties. The method then includes bridging the phone connections to establish the phone call between the parties.

In accordance with another embodiment, a method for establishing a phone call between a caller and a recipient is defined. The method includes receiving a text message from a mobile device, and the text message identifies a type of call action and a recipient phone number for the recipient. Then, processing the text message to identify the recipient phone number and a receiving phone number of the caller. The method initiates a call request to establish a caller connection for the caller followed by a recipient connection for the recipient. A bridge is then established between the caller connection and the recipient connection to enable voice data to travel for the call action between the caller and the recipient.

In accordance with yet another embodiment, a method for establishing a phone call between an originator and a recipient is defined. The method includes receiving a text message from a mobile device, and the text message identifying a type of call action and a recipient phone number for the recipient. The method further includes processing the text message to identify the recipient phone number and a receiving phone number of the originator. Then, initiating a call request, where the call request causes the: (i) forwarding of a call invite to the receiving phone number of the originator; (ii) detecting acceptance of the call invite at the receiving phone number of the originator to establish an originator connection; (iii) forwarding a call invite to the recipient phone number; and (iv) detecting acceptance of the call invite at the recipient phone number to establish a recipient connection. The method then moves to establishing a bridge between the originator connection and the recipient connection to enable voice data to travel for the call action between the originator and the recipient.

In accordance with still another embodiment, a computing device implemented method for establishing a phone call between a caller and a recipient or a caller and recipients is provided. The method includes receiving a text message from a text capable communication device, where the text message identifies at least one of a type of call action and a recipient phone number for the recipient. The method then processes the text message to identify the recipient phone number and a receiving phone number of the caller, where the processing determines a time and date for the phone call. At a stated time and date, the method initiates a call request to establish a caller connection for the caller followed by a recipient connection for the recipient. Then the method establishes a bridge between the caller connection and the recipient connection to enable voice data to travel for the call action between the caller and the recipient. The receiving phone number of the caller is either a phone number at a location or device from which the text message was sent or another identified phone number, as identified in the text message.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1A illustrates the environment for setting up phone calls via a text messaging capable device, in accordance with one embodiment of the present invention.

FIG. 1B illustrates a broad overview of one process that can be used to establish a phone call in response to receipt of a text message, in accordance with one embodiment of the present invention.

FIGS. 2A-2D illustrate methods that can be used to process text messages in order to establish a phone call between selected parties, in accordance with one embodiment of the present invention.

FIGS. 3A-3C illustrate processes used by a call bridge establishing provider in order to process text messages and establish a phone call, in accordance with one embodiment of the present invention.

FIGS. 4A-4B illustrate method operations used to register a phone number of a phone, so as to enable registered phone text messages to establish phone calls, in accordance with one embodiment of the present invention.

### DETAILED DESCRIPTION

An invention is described for methods and computer driven operations for enabling the setup and connection of phone calls, in response to receipt and processing of a text message. The text message can be received from any device that is capable of generating text and communicating the text over a network. Broadly speaking, the network can be one or a combination of the Internet, phone company networks, cellular phone networks, radio frequency networks, companies that can terminate to PSTN networks, and the like. The text message is preferably addressed to a particular server that can process the text message, identify a type of call that is desired by the sender of the text message, and then can generate voice stream connections to each of the parties that are to be connected for the phone call session, and then bridge the voice stream connections to each of the parties so that the phone call session is activated, and the parties can communicate.

It is noted that the phone call can be established between any party, as may be dictated in the text message. The party texting the request may wish to be part of the phone call with another phone number, or the party texting may simply wish to establish a phone call between two or more other parties. Thus, the text message can be sent to set up a conference call at a particular time, to immediately initiate a call, or establish calls between other people that that text message sending person wishes to set up. It should be understood that reference to “phone numbers” is used herein to define one example way of identifying a party. Other alternative ways of identifying a party may include, without limitation, shortcodes, user IDs, and the like. Additionally, reference is made to “phone calls,” but a “call” can be made to set up a voice connection, a video and/or data connection, or combination of other data connections.

In one embodiment, as the set up of the phone calls is triggered in response to the text message, the person sending the text message may need to have an account set up so that requested calls can be charged accordingly. For instance, if the text message is sent using a cell phone, the person sending the text message may register the phone (or device) used to send the text message. By registering the phone, the provider of the call setup services can bill the phone number that initiated the text-based phone call request.

For example purposes, the person sending the text message may be charged a fee for sending a text message by his or her cell phone provider. Additional fees may include: (a) local phone company charge (e.g., PSTN leg/minute) for the leg between the provider that processes the text message and the first party to the call; (b) local phone company charge (e.g., PSTN leg/minute) for the leg between the provider that processes the text message and the second party to the call. Depending on whether the phones of the first or second party are cell phones, the parties may receive a charge for air time. The mentioned charges are noted for illustrative purposes only, as it is understood that charges always change.

In current 2006 US Dollars, if a person having a United States phone wishes to call Italy by first texting, the illustrative costs may be about 5 cents for a text message (e.g., SMS text charge), about 2 cents for a United States PSTN leg, and about 15 cents for an international PSTN leg (e.g., total of about 22 cents for the first minute and 17 cents/minute afterwards). Comparatively speaking, in 2006 US Dollars, the same call made by a regular phone call dialer, having no discretion on phone networks that will be used, may cost in the range of 50-200 cents/minute. Aside from the technical benefits of call setup, conference setup, third party call setup (and others noted below), the cost savings over traditional phone call initiation is substantial. For purposes of clarity and broad construction, the following description will be provided without further mention of benefit costs, as cost savings are simply an added benefit to the technical advantages over conventional phone call setup.

It will be obvious, however, to one skilled in the art, that the present invention may be practiced without some or all of these specific details. In other instances, well known process operations have not been described in detail in order not to unnecessarily obscure the present invention. The various embodiments will thus be described in accordance with the order of the drawings, but without limitation to any particular structure or configuration, as they are provided to illustrate the many permutations, combinations and/or alternatives, within the spirit and broad scope of the enumerated claims.

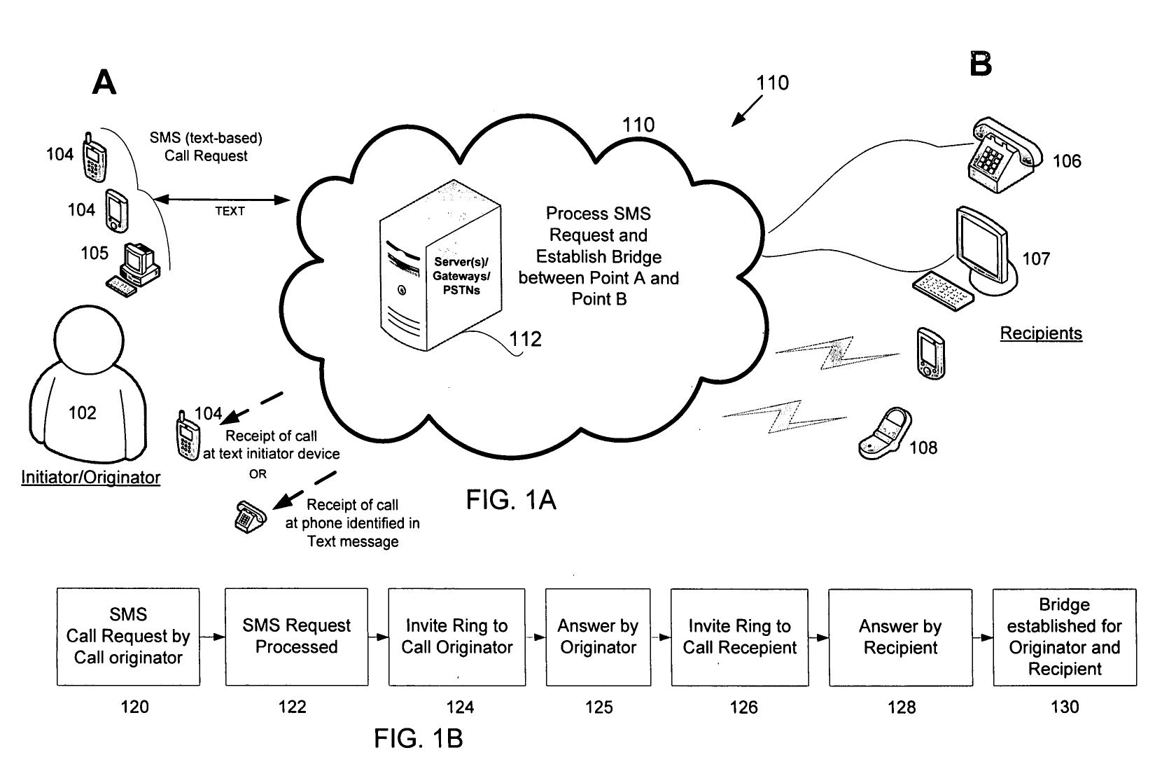

FIG. 1A illustrates a phone call establishing environment 100, in accordance with one embodiment of the present invention. Phone call establishing environment 100 may include a user 102 that is using a mobile texting device 104. In this example, the mobile texting device 104 may be a cell phone, personal digital assistants (PDA), or the like. In other embodiments, the mobile texting device 104 can be embodied in any type of communication device (wired or wireless (e.g., WiFi)) that is capable of creating text messages and transmitting the text messages over a network. Examples of texting devices can include PDAs, laptop computers, tablet PC's, or any other type of device that is capable of receiving text-based messages and communicating the text-based messages over a network.

In still another embodiment, the user 102 can enter a text message over a standard computer 105 that has access to the internet. In such an example, the computer should have access to a text messaging application (e.g., WEB application) that will enable the user to text message a phone call request over a network. In one specific example, the user 102 is using a mobile texting device 104 to process a text message in the form of a short message service (SMS) message, which is communicated over a wireless or connected network to the communications network 110.

In this example, the communication's network 110 is provided in the form of a plurality of interconnected computers or processing devices that establish communication links between nodes of a network. In one embodiment, the communications network 110 will include a number of servers which are internet based or non-internet based that can be used to establish communication links between nodes of the network. For instance, the communications link 10 is capable of receiving data, packet data, IP data, TCP/IP data, text data, cell phone calls, etc. and is capable of processing those communications on or over the network. The processing can include forwarding the data to a desired server or end point for further processing. In this example, the communications network 110 should be broadly construed to include both internet based and non-internet based communication systems, which will enable processing of messages and phone calls between users desiring to establish phone call communications.

In one embodiment, the communications network 110 will include a server 112 that is capable of establishing a bridge between point A and point B. In this example, point A may be user 102 desiring to make a phone call with a user that is using a wired phone 106, a soft phone 107, PDAs or a cell phone 108. The server 112 is illustrated as a single server, although it should be understood that one or more servers may be involved in the processing of a call connection between point A and point B. The number of servers may include internet servers, gateway servers, routers, dedicated call initiation servers, servers/systems configured to handle traffic over public switched telephone networks (PSTN), etc.

Broadly speaking, one embodiment of the present invention provides a method that will enable a user 102 to send a text message to a communications network 110, where a server 112 (or servers) will process the text message to establish a bridge between point A and point B. As noted above, the text message may be generated on a mobile device 104 or it can also be generated on a computer 105 connected to the internet. In either case, the text message is forwarded to server 112 over the communications network 110, where the server 112 will process the text message to identify which phone numbers the user 102 wishes to call and then establish calls to the phone numbers identified by user 102 for each of the endpoints the user wishes to establish a phone call.

In one example, the user may wish to establish a phone call between the mobile device 104 and some phone number at point B. In such a case, the server 112 after examining the text message will establish a phone connection with the mobile texting device 104 and then establish a connection with a phone at point B. Once both connections are established, the server 112 will negotiate the connections such that both connections are linked and a phone call is established between point A and point B.

FIG. 1B illustrates one embodiment, defining the operations performed to establish a bridge between an originator and a recipient, such that a phone call is established between the two. In this example, the method begins at operation 120 where an SMS call request is generated by a call originator. The call originator may be the user 102 that typed the original SMS text message to the server 112. The SMS request is processed in operation 122. Processing of the SMS request includes parsing the SMS text message to identify the phone number that the user 102 is desiring to call as well as the phone number that the user 102 wishes to receive a call to establish a phone call connection. In one embodiment, the originator's phone number can be any phone number identified by the originator, and does not have to be the same phone number that is associated with a mobile texting device 104. In such an example, the user 102 may wish to set up a phone call using the SMS request and identify a phone number at which the user 102 wishes to receive a call to establish the phone call between point A and point B.

The processing of the SMS request in operation 122 will also include the identification of the phone number that will be the recipient of the phone call request. The recipient may be a single recipient or a number of recipients in case of a conference call setup. Additionally, in the SMS request processing, it is determined whether the phone call is desired to be between point A and point B or if a phone call is desired to be between point B and some other point, where the originator is not involved in the phone call. In either scenario, the processing of SMS request in operation 122 will include parsing of the SMS text message to identify the parameters set by the user 102, which will request a type of phone call to be made by the server 112.

Assuming that the user 102 is the call originator, in operation 124 the server 112 will provide an invite ring to the call originator. The invite ring to the call originator may be performed by an internet call handling server that processes a method that can place a phone call between the internet and a non-internet based phone connection. As will be described below, the internet call handling process can be performed using any number of protocols. Some examples of protocols may be a session initiation protocol (SIP), an extensible messaging and presence protocol (XMPP), and interdomain access control (IAC), or any other protocol that is capable of initiating, managing, and breaking down connections and sessions to establish phone calls, manage phone calls, and broker operations associated with a phone call.

In operation 125, the originator will answer the phone call invite which will signify the establishment of a connection between the server 112 and the originator's phone. In operation 126, an invite ring is established to a call recipient. In the same way that the invite ring is processed to the originator, the server 112 will establish a connection to the call recipient. In operation 128, the connection is established when the recipient answers the invite ring. Server 112 will then perform negotiation 130 of the connections to the originator, and the recipient to establish a bridge between the originator and the recipient. Once the bridge is established, a connection between the originator and the recipient is defined and a phone call can proceed.

It is again noted that the server 112 can be a single server, multiple servers, multiple computing devices, internet routing hardware, software, and routing capabilities that are capable of processing the receipt of a text message, processing of the text message, establishing phone calls to various phone numbers, and bridging two or more phone connections as defined in the text message that originated the request for a phone call.

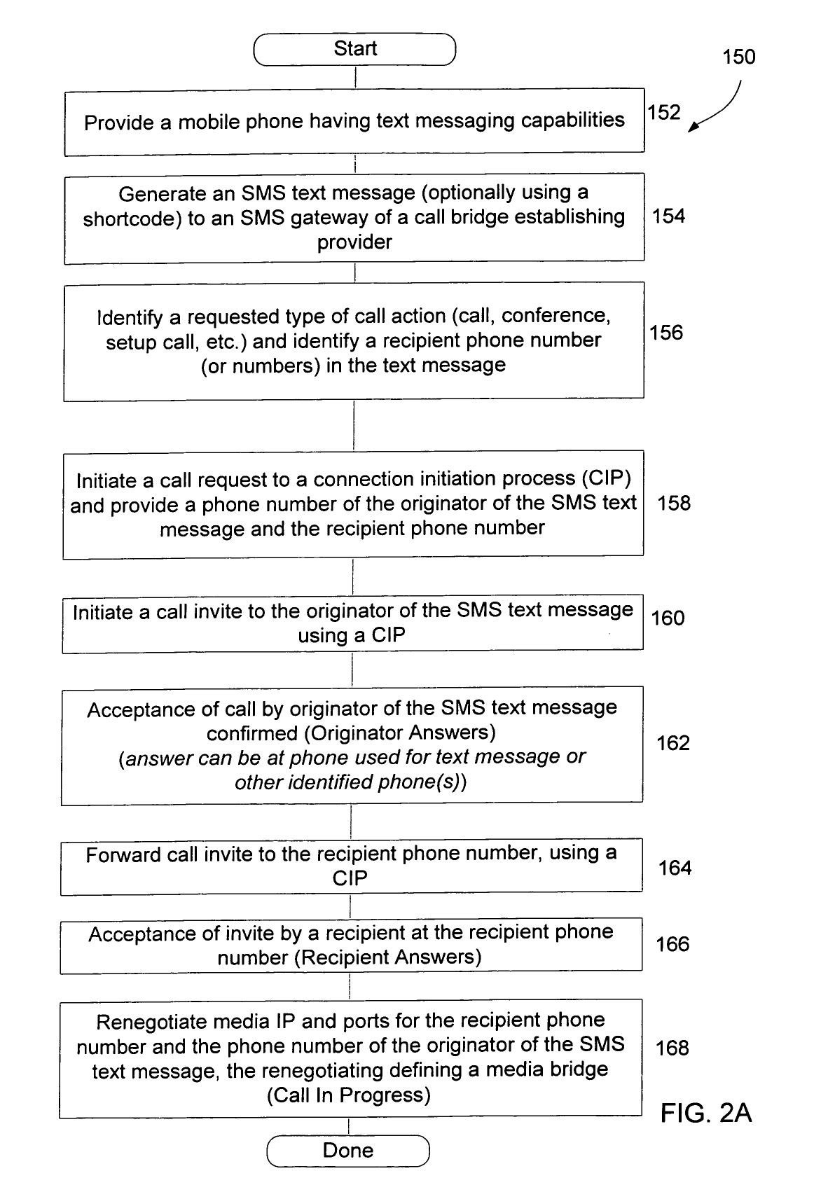

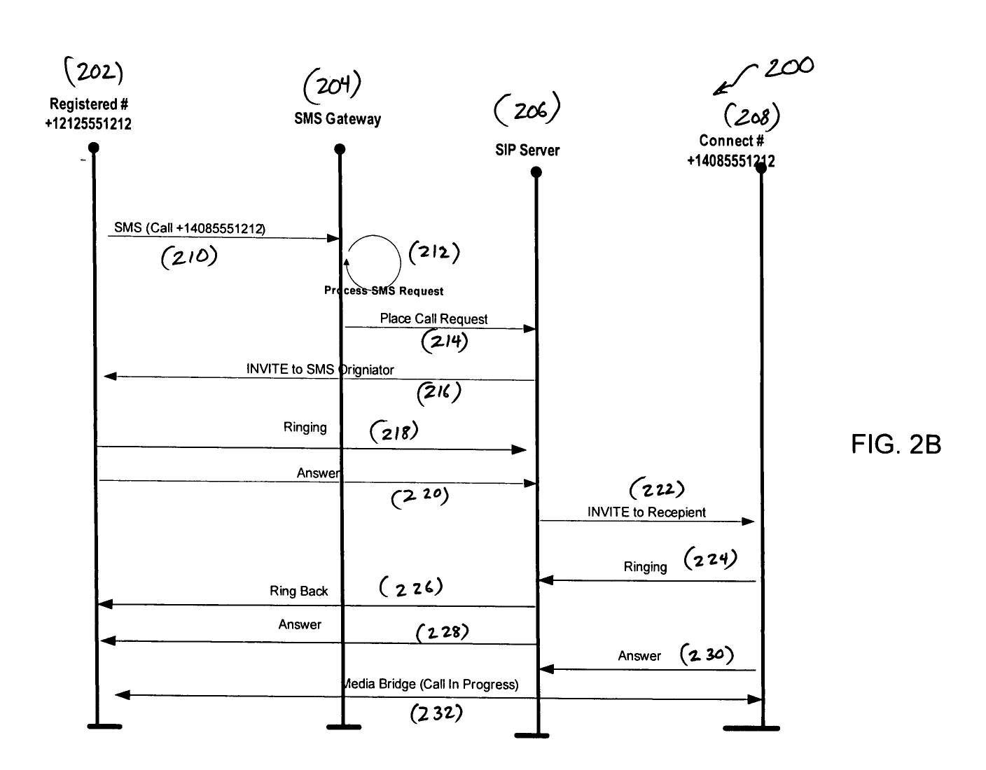

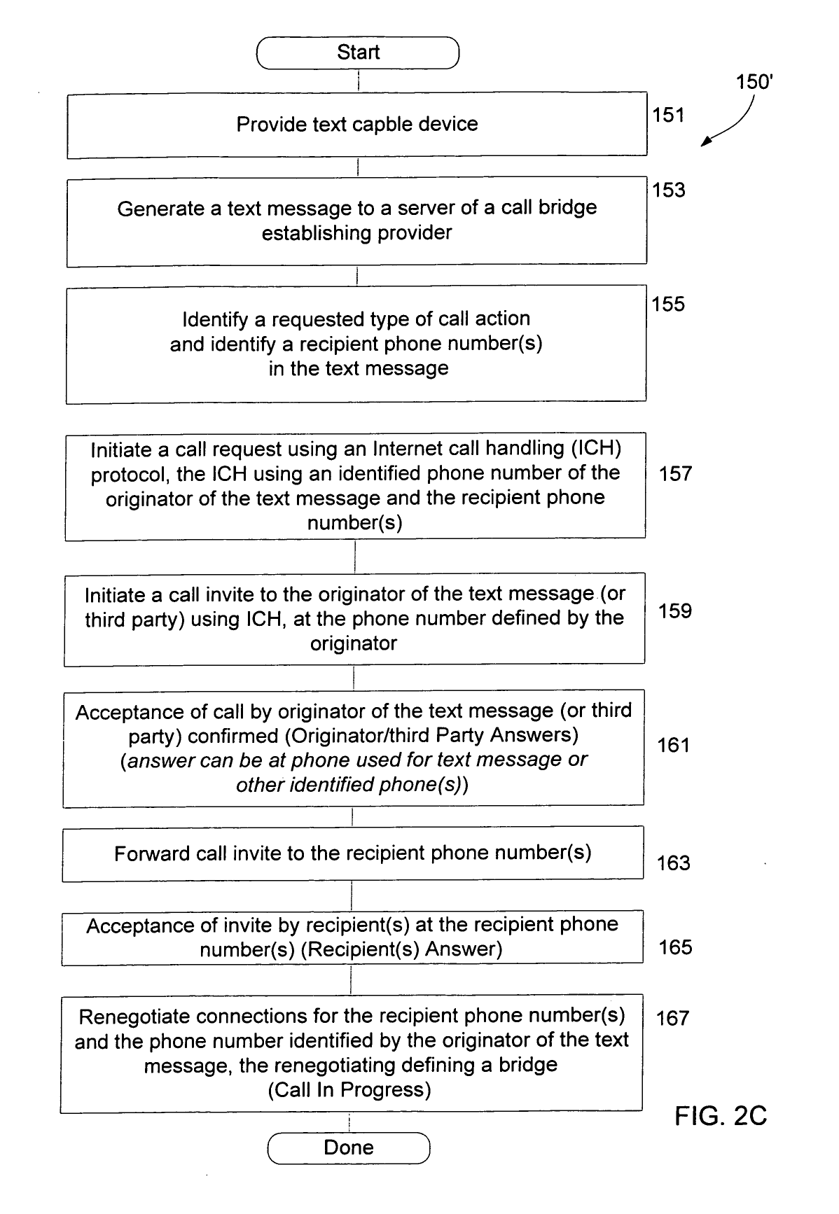

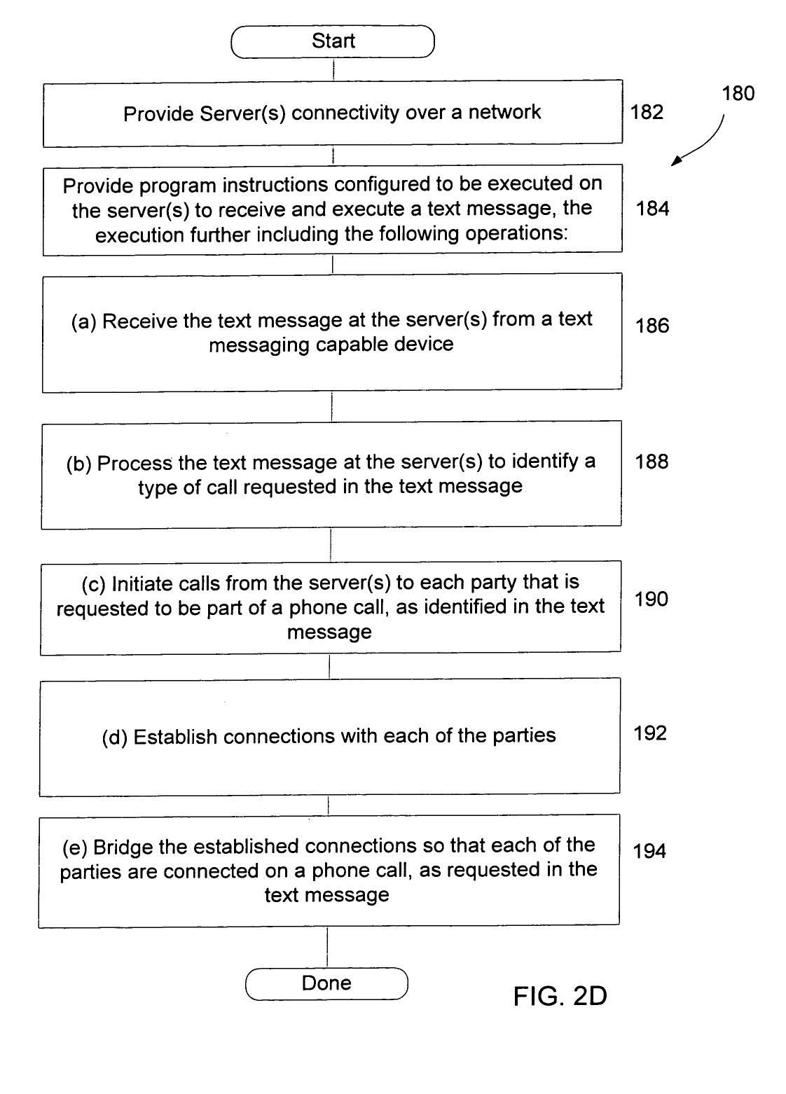

FIG. 2A illustrates a flow process 150 that can be used to establish a phone call between two or more parties in response to receipt and processing of a text message, in accordance with one embodiment of the present invention. The method begins at operation 152, where a mobile phone having text message capabilities is provided. In alternative embodiment, the mobile phone can be replaced with any device that is capable of generating a text message. The method then moves to operation 154 where an SMS text message is generated and forwarded to an SMS gateway of a call bridge establishing provider. An SMS gateway can be defined as a server or computer that is connected to a network and is designed to receive the specifically addressed SMS text message.

The call bridge establishing provider, in one embodiment, is an entity that has control of the processing operations performed when receiving a text message, processing the text message, generating phone calls to phone numbers as defined in the text message, establishing connections, and bridging the connections. Accordingly, a call bridge establishing provider may provide some of the servers 112 of FIG. 1A which, as defined above, can include a number of servers, computers, or processing entities that are designed to establish gateways, connections, and services for receiving the text message and processing the text message to establish the desired phone calls.

Still referring to operation 154, the SMS text message may optionally be sent to an SMS gateway using a phone number (e.g., a longcode), or a shortcode. A shortcode, also known as short numbers or common shortcodes (CSC), are special telephone numbers that are significantly shorter than full telephone numbers. They are generally designed to be shorter to read and easier to understand and remember than normal length telephone numbers. While they may be similar to telephone numbers, they are, at the technological level, unique to each operator, all the providers generally have agreements to avoid overlaps in shortcodes. Thus, if the SMS text message is forwarded to a shortcode in operation 154, the shortcode will point to the SMS gateway of the call bridge establishing provider. In still another embodiment, instead of calling a specific telephone number, a user may simply type in a user ID. A number of companies, such as Yahoo, Inc. (e.g., Yahoo ID), Microsoft (e.g., MSN ID), and others, have established IDs for users, based on their registered account. As such, a call can be made to a user ID, in the same manner that a call is made to a telephone number or a shortcode.

In operation 156, a requested type of call is identified as well as a recipient phone number as defined by the originator of the text message. The type of call may be a simple call connection between the originator of the text message and another telephone number, or the call action can be a conference call between the originator of the text message and one or more people having different phone numbers, or a call setup. A call setup may be where the originator of the text message identified two or more phone numbers that will be connected at a point in time. In the example of flow process 150, it is assumed that the generator of the SMS text message is desiring to establish a call between him or herself, and another phone number.

The call bridge establishing provider in operation 158 will initiate a call request to a connection initiation process (CIP), and provide a phone number of the originator of the SMS text message, and the recipient phone number as identified from the text message. The CIP may be processed by a particular server (or computing device) that is capable of establishing phone connections over a network and link the call request to traditional phone networks (e.g., PSTN) that will enable calls to be processed to any phone that is provided with a phone number. As noted above, the CIP processes protocols defined by any number of standards that are capable of establishing, managing, and tearing down phone calls. Some examples of CIPs include session initiation protocol (SIP) handling systems, extensible messaging and presence protocol (XMPP) systems, interdomain access control (IAC) systems, or other protocols and systems that are capable of establishing connections, managing connections, and/or tearing down connections.

In operation 160, a call invite is initiated to the originator of the SMS message using a CIP. As noted above, the CIP is capable of establishing a phone connection that that is assigned an IP address and port number, and is capable of linking an internet based connection to a non-internet based phone that has a regular phone number. In specific examples, a CIP may be using an SIP process that is capable of performing SIP to PSTN connections to enable an originating internet based call to be forwarded to a PSTN system that links to a standard telephone number. The telephone number may be of a cellular phone, a standard land line, a soft phone, or any other device having a phone number.

In operation 162, acceptance of the call invite by the originator of the SMS text message is confirmed. In this embodiment, the CIP is attempting to detect when the originator answers the phone call so that a connection can be established between the CIP and the phone number identified for the originator of the text message. It should be understood that the answer can be at a phone used for the text messaging, or any other phone identified by the originator at which the originator wishes to receive the phone call. In operation 164, a call invite is forwarded to the recipient phone number using the CIP. In a similar manner, if the CIP is using SIP to establish a connection, SIP is capable of brokering the communication and also interconnecting the SIP phone connection to a PSTN phone connection so as to reach the recipient phone number.

In operation 166, acceptance of the invite call by the recipient at the phone number is confirmed by having the recipient answer the phone. Once the SIP confirms that a connection is established to both the originator's phone number and the recipient's phone number, by way of answers from both the originator and the recipient, the operation moves to 168 where media IP and ports are re-negotiated for the connections associated with both the originator and the recipient. At this point, a media bridge is said to have been established (e.g., between terminating endpoints) and a call can be in progress between the originator's phone number that was called and the recipient's phone number that was called, both of which answered so as to establish the call.

In one embodiment, negotiation of the media IP and ports can occur in the following manner. When the originator's phone rings and the originator answers, the IP and port information from the initiator is obtained, over which the voice stream will be sent. When the call is placed to the recipient's phone number, the call is placed with the IP and port information of the initiator. When the recipient answers, the IP address and port information of the initiator is obtained. In a next process, the IP address and port information of the destination is forwarded to the originator, so the originator knows where to send the voice stream (i.e., to the recipient phone number).

FIG. 2B illustrates a process point flow 200 for establishing a phone call between a registered number 202 and a connect number 208, in accordance with one embodiment of the present invention. The process point flow 200 is one specific example where the originator is making a text message call request from a registered phone number. In one example, the registered phone number may be for a mobile phone that has a phone number associated therewith, and the phone number for the mobile phone has been registered with the call bridge establishing provider. In operation 210, the user of the registered number 202 will generate an SMS text message to an SMS gateway 204. In the SMS text message, the user will identify the connect number 208 that the user wishes to call. The SMS gateway 204 may be identified by the SMS message by sending a shortcode that will identify the specific SMS gateway 204 of the call bridge establishing provider.

In this example, the SMS gateway 204 will process the SMS request in operation 212. The processing of the SMS request 212, in one specific example, may include transforming the SMS request into an HTTP request. Then, a unique header may indicate the SMS originating phone number of the registered number 202. The body of the HTTP request is the actual SMS text message. Then, a method handler parses the HTTP body (SMS request call plus 14085551212) and marshals this into an SIP server, which sends the originating phone number (HTTP header) and destination phone number (content of the SMS). At this point, the SMS server 206 has received the place call request 214 as well as the information associated with the originating phone number as well as the connect phone number.

The SIP server 206 will then send an invite to the SMS originator in operation 216. The SMS originator 216, in this example, is the register number 212. As noted above, however, the register number 212 may place the SMS call and also indicate that the SMS originator wishes to receive the call at another number that is different than the registered number. In either case, the registered number 202 will be the one that originates the SMS text message and will be charged with any fees associated with generating the call even if the invite to the SMS originator is sent to another number other than the registered number 202. Having this understanding in mind, the specific example of the process point flow 200 will described the situation where the call is placed back to the registered number for ease of description, without limitation to this specific feature.

In operation 218, therefore, the registered number 202 will ring, which is then communicated to the SIP server 206. When a user at the registered number answers in operation 220 the SIP server will detect the IP and port information coming from the registered number 202 that answered the phone, over which the voice stream will later be sent. In operation 222 an invite is sent to the recipient at the connect number 208 from the SIP server 206. The SIP server 206 will place the second call to the connect number in operation 222 with the IP and port information of the registered number 202. In operation 224, the connect number 208 is shown to be ringing and SIP server 206 will detect the ringing at the connect number 208.

The SIP server 206 will then communicate that ring back to the registered number 202 in operation 226. When the connect number 208 answers in operation 230, the IP and port information of the connect number 208 is gathered by the SIP server. The answer is communicated back in operation 228 to the registered number 202 and the IP and port information of the connect number 208 is forwarded to the registered number 202 by the SIP server in operation 232 so that the registered number 202 is aware of and connected to the IP and port information of the connect number 208, so that the registered number 202 is able to send the voice stream to the IP and port information data of the connect number 208. At this point, it is said that the registered number 202 and the connect number 208 are bridged and a call may be in progress as the connection established by the SIP server 206 to the registered number 202 and the connect number 208 has been negotiated and the voice stream between the registered number 202 and the connect number 208 are synchronized and can enable the call to proceed.

FIG. 2C illustrates a call establishing process 150′, in accordance with another embodiment of the present invention. The method begins at operation 151 where a text capable device is provided. The text capable device can be a mobile or non-mobile competing device. Examples of text capable devices can include cell phones, laptop computers, computers coupled to the internet (wireless or not), tablet computers, or any other computing device that is capable of receiving text, and transmitting text over a communications medium to a recipient target of the text message. As noted above, example text type messages can include SMS type text messages.

In operation 153, a text message is generated to a server of a call bridge establishing provider. The server of the call bridge establishing provider can be a gateway server, or a number of servers that are interconnected over a network. The network can include a cellular phone network, a standard PSTN network, or the internet. In either embodiment, the text message is forwarded to a server that is capable of processing the text message and is part of a call bridge establishing provider system(s). In operation 155, the requested type of call action is identified as well as the recipient phone numbers as defined in the text message. The call action can be a request to connect the sender of the text message to a particular phone number or the request to establish a conference call between a number of phone numbers, or to schedule a phone call between two or more numbers at a particular point in time. When the type of call action is to establish a phone call at a particular point in time, the process can facilitate scheduling the phone calls and bringing people together for call at a desired point and time.

A call request is then initiated at the call bridge establishing provider using an internet call handling protocol. The internet call handling protocol is similar to the Connection Initiation Process (CIP) defined above. Additionally, the Internet Call Handling (ICH) protocol can be anyone of the described protocols, such as SIP, XMPP, IAC, or any other call initiation, management, or call teardown protocol having this functionality. In one very specific example, but without limitation, the ICH protocol may implement the SIP protocol described above. Continuing with the broad definition of internet call handling, the ICH will use the identified phone number of the originator of the text message and the recipient phone numbers. The identified phone number of the originator can be the same phone number that is associated with the device used to generate the text message or another phone number at which the originator wishes to receive a phone call. The ICH will also have the phone numbers of the recipient or the recipients as identified in the text message.

In operation 159, the ICH will initiate a call invite to the originator of the text message (or a third party). It is again noted that the call invite can be to the originator at any phone number and preferably the phone number identified by the originator in the text message. In another example, the phone number of the originator is simply the same phone number that is registered to the text capable device. In operation 161, confirmation of acceptance of the call by the originator of the text message is established. Confirmation can be in the form of having the originator or third party answering the phone upon receiving the call from the ICH. In operation 163, the ICH will forward the call invite to the recipient phone numbers. Acceptance of the invite by the recipients at the phone numbers is then confirmed in operation 165 when the recipients answer. In operation 167, connections for the recipient phone numbers and the phone number identified by the originator of the text message are renegotiated so as to define a bridge between the phone number that was answered by the originator and the phone number that was answered by the recipient.

As mentioned above, renegotiation of the connections is established by detecting the IP address and port numbers of each of the connections between the ICH and the originator phone number and the ICH and the recipient phone number. In this manner, the voice stream can be bridged together between the two points. In one embodiment, the ICH is also charged with communicating with internet and non-internet gateways and servers/hardware to establish the connection. In some instances, when the ICH protocol is operating as an SIP protocol, the SIP protocol will perform a connection between SIP and PSTN to enable a connection between the SIP handling device and the phone number identified in the text message.

FIG. 2D illustrates a process 180 where a call bridge establishing provider will execute program instructions to enable the processing of text messages and establishing the phone calls to generate call bridges, in accordance with one embodiment of the present invention. In operation 182, servers are provided with connectivity over a network. The servers can be in the form of server computers coupled to the internet, intranets, gateways, PSTN networks, etc. In some examples, the process may be performed by a single server, or multiple servers although the processing appears to be uniformly performed by a single processing entity. Thus, the program instructions can be executed in a distributed manner to achieve the desired execution to enable receipt of a text message and then establishing of a phone call between two points.

In operation 184, program instructions are provided and configured to be executed on the servers to receive and execute text messages. The execution is configured to perform the operations defined in 186-194. In operation 186, the text message is received at the servers from a text messaging capable device. In operation 188, the text message received by the servers is processed to identify a type of call requested in the text message. In operation 190, the servers will use a protocol to initiate calls from the server to each party that is requested to be part of a phone call as identified in the text message.

In operation 192, connections with each of the parties is established. Establishing the connections will include identifying IP addresses and ports for each of the parties that are to be part of the phone call. In operation 194, a bridge is established such that connections of each of the parties are coupled to a phone call as requested in the text message.

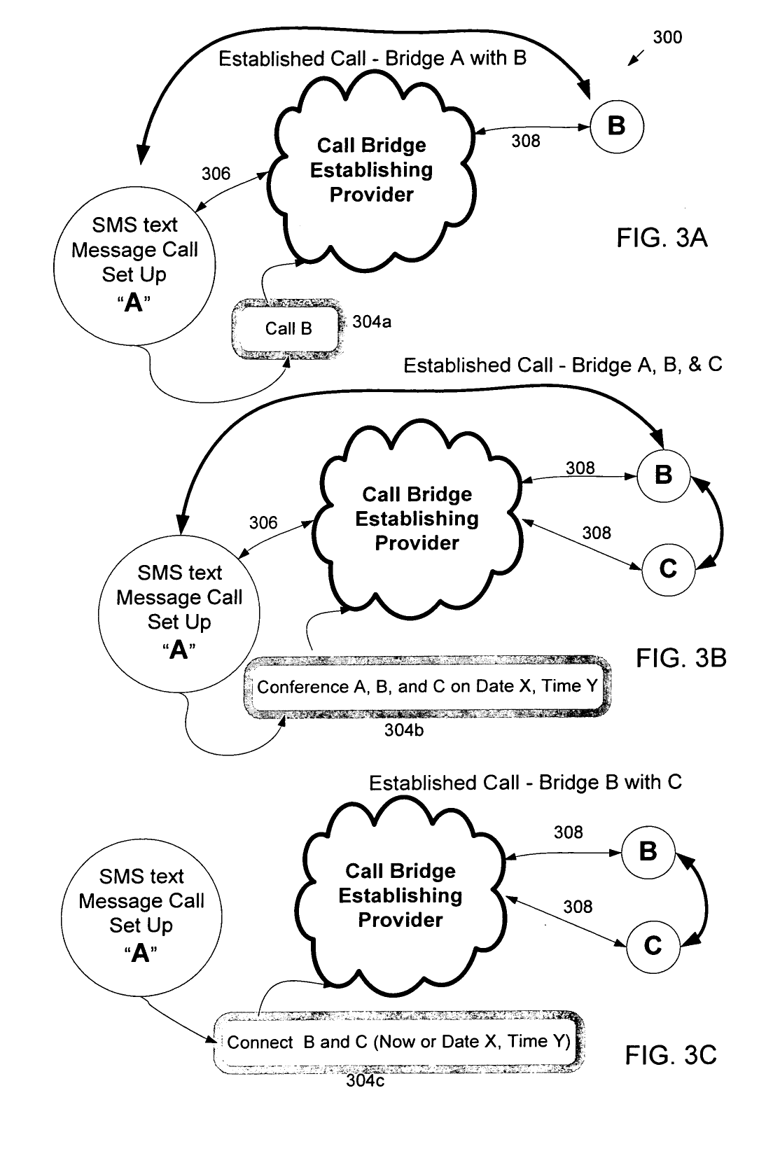

FIGS. 3A through 3C illustrate examples where a call bridge establishing provider 302 handles text messages that request connections to be made for a phone call or phone calls, in accordance with one embodiment of the present invention. In FIG. 3A, a user of a text capable device will send an SMS text message call setup by issuing a text message 304a that is communicated to the call bridge establishing provider 302. As noted above, the call bridge establishing provider 302 is an entity that will provide the processing infrastructure for receiving text messages, processing the text messages, and establishing phone calls and connections that define the bridge. In the example of FIG. 3A, the SMS text message 304a was one that requested a call to be made to B. The call bridge establishing provider will then establish a connection between a connection protocol process of the call bridge establishing provider and the phone number for A in connection 306 and establish a connection 308 with B.

Once the call bridge establishing provider 302 defines the connections 306 and 308 between A and between B, the call bridge establishing provider executes instructions that will bridge the connections 306 and 308 together to form a phone call between A and B.

FIG. 3B illustrates an example where a user sends a text message call setup from A to the call bridge establishing provider via text message 304b. Text message 304b will include a call identification type of conference. The conference will identify that the text message would request that a conference be setup between A, B, and C on a particular date X and time Y. This message is then processed by the call bridge establishing provider and based on the information execution is provided to control when the connection 306 between A and the call bridge establishing provider 302 is set and the connections between the call bridge provider and B and C. Assuming that the date X and time Y have arrived, the call bridge establishing provider will first generate the connection 306 and then generate connections 308 to B and C. In a next operation, the call bridge establishing provider will negotiate the IP address and port information data of connection 306 and connections 308 to enable communication bridging and establish a conference call between A, B, and C.

FIG. 3C illustrates an example where the person sending a text message at point A will send a text message 304c to the call bridge establishing provider 302. In this example, the type of call is to connect B and C. The connection of B and C can either be now or at a later time when date X and time Y have arrived. It should be noted that the SMS text message from A was sent to the call bridge establishing provider 302 to request that a connection between B and C be formed. In such an example, A will not be part of the conference or call and B and C will each be connected by a call bridge. Thus, the call bridge establishing provider will contact B to establish a connection 308 with B and then contact C to establish a connection between C and the call bridge provider. The call bridge establishing provider will then renegotiate the IP addresses and ports of each of B and C in order to bridge the connections and allow a voice stream to occur between B and C.

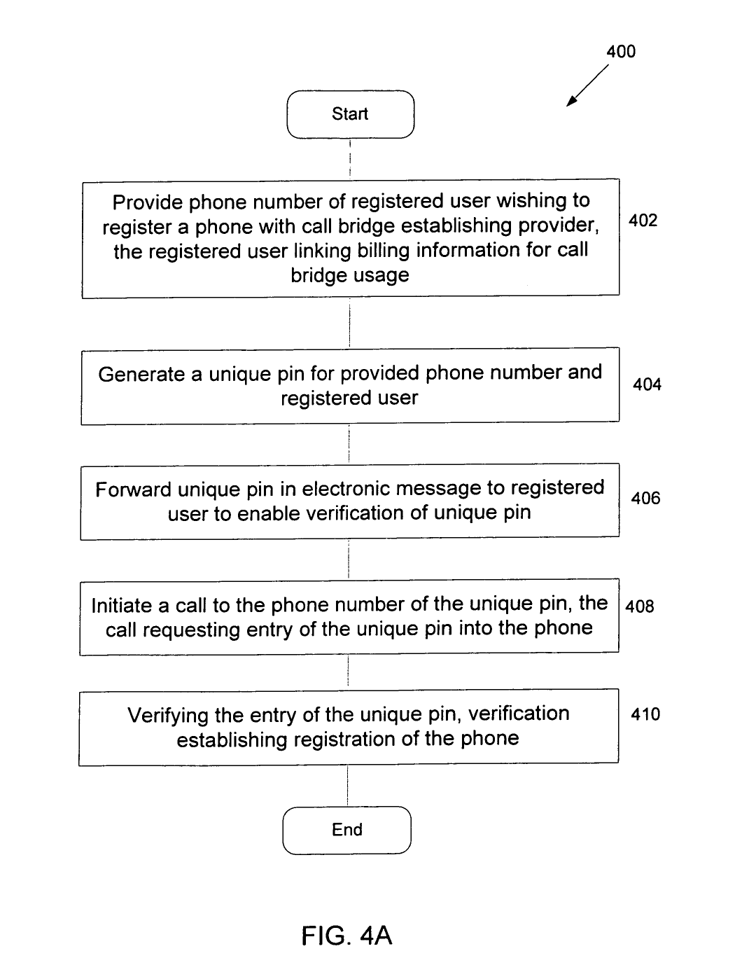

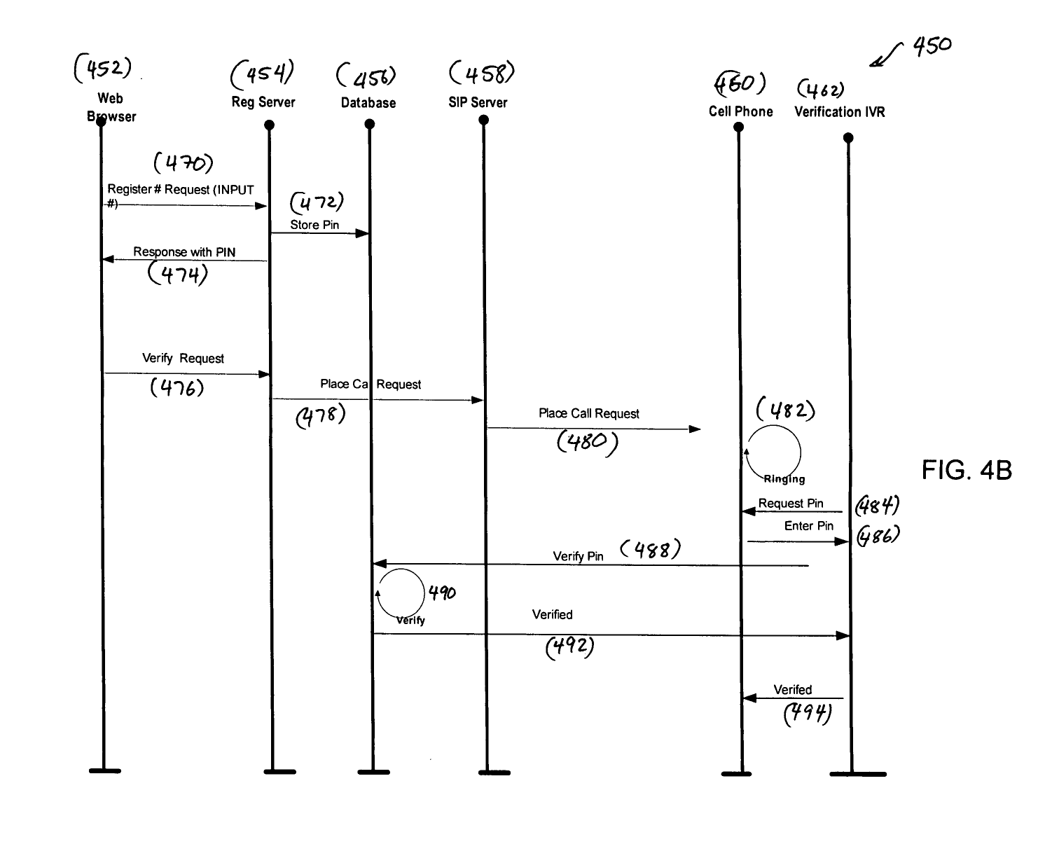

FIG. 4A illustrates a method process that may be used to register a particular phone having a particular phone number with a call bridge provider. In this example, the method begins at operation 402 where a phone number of a registered user wishing to registering a phone with a call bridge establishing provider is provided. In this example, the registered user will be asked to link the registered phone number with billing information for call bridge usage and other usage. The billing information may be in the form of an internet wallet, or account that is charged to the user of the registered phone. The user of the registered phone or mobile device, or message capable device is then linked so that any text messages that are sent from that device are registered so that the established phone calls between the desired points are charged to the registered device (or person), that sent the text message.

In operation 404, a unique pin is generated for the provided phone number and registered user. In operation 406, the unique pin is forwarded in an electronic message to the registered user to enable verification of the unique pin. Then in operation 408, a call to the phone number of the unique pin is initiated by the call bridge establishing provider and the call will request entry of the unique pin into the phone. This process will ensure that the user that is attempting to register a phone number is in fact the rightful holder of that phone and associated unique pin. In operation 410, the entry of the unique pin is verified by the call bridge establishing provider and if the unique pin matches, verification is established for the phone number and the phone is considered to be a registered phone number.

FIG. 4B illustrates one example of a state flow 450 for registering a phone number on a device that may be used to forward call requesting text messages, in accordance with embodiment of the present invention. The state flow 450 will illustrate an example of process operations performed between a web browser 452, a registration server 454, a database 456, and SIP server 458, a cell phone 460, and a Interactive Voice Response (IVR) verification 462. The state flow 450 begins at operation 470 where a user wishing to register a phone number of a device capable of text messaging is prompted to go to a web browser and enter a phone number to register in operation 470. In one embodiment, the web browser 452 may be of the call bridge establishing provider. The call bridge establishing provider may also require that the user be a registered user and have a user ID. One specific example, may be to have the call bridge establishing provider to be an internet company. The internet company may be, for example Yahoo, Inc., the Assignee of the present application or any other company that can establish the infrastructure and carry out the processing operations defined herein.

In one embodiment, the registered user having a user ID may also be associated with a registered billing account that will allow the user to be charged for usage of the phone calling services. Again, in one specific example, the provider may be Yahoo, Inc. and Yahoo, Inc. may have a service called “Phone Out” accounts that enable a registered user to deposit money into the account so that a tab or deductions can be made from the account based on the usage desired by the user. Additionally, the registered number should be of a valid phone. A valid phone is one that is capable of processing text messages, and the text messages can be in the form of an SMS message or other type of text message.

Returning to FIG. 4B, the registration server 454 will generate a unique pin and store the unique pin in operation 472 into a database 456. The registration server 454 will then return the pin back to web browser in operation 474. The unique pin can be displayed on the web page and the user is prompted to verify that the pin is for the registered phone number that they are attempting to register. An email can be sent to the users email account with the pin, and a link that the user can click will verify that the user that is accessing the web page is also the user that received that email from the email account. The verification request in operation 476 is then provided to the registration server 454. The registration server 454 then forwards a command to place a call request 478 that is sent to an SIP server. As noted above, the SIP server 458 is one that can establish a call to a requested phone number. The SIP server 458 will then place the call request 480 to the cell phone 460. The cell phone 460 is the one that may be associated with the registered number.

In operation 482, the cell phone is shown to ring and the cell phone is provided a message 484 that requests a pin from a verification IVR 462. The user of the cell phone 460 will then enter the pin in operation 486 into the cell phone which is then communicated back in operation 488 to the database for verification. The verification process 490 confirms that the pin entered at the cell phone is the pin that was assigned to the user for that phone number. In operation 492, a verification signal is sent from the database 456 to the verification IVR, which then confirms verification in operation 494. Interactive Voice Response (IVR) is an automated telephony system that can interact with callers, gathers information and routes calls to the appropriate recipient. An IVR system (IVRS) can be set to accept a combination of voice telephone input and touch-tone keypad selection and can be set to provide appropriate responses in the form of voice, fax, callback, e-mail and perhaps other media. An IVR system consists of telephony equipment, software applications, a database and a supporting infrastructure.

As used herein, reference is made to internet based calls and handling, and such terminology should not be limited to any specific protocol. Other example protocols may include Voice over Internet Protocol, also called VoIP, IP Telephony, Internet telephony, Broadband telephony, Broadband Phone and Voice over Broadband. This protocol routes voice conversations over the Internet or through any other IP-based network. With this understanding in place, it should be understood that VoIP calls can also move to and from PSTN calls.

The public switched telephone network (PSTN) is the concentration of the world's public circuit-switched telephone networks. PSTN networks can be either fixed-line analog telephone systems or digital systems, and the network can include mobile as well as fixed telephones. The PSTN is primarily governed by technical standards created by the ITU-T, and uses E.163/E.164 addresses (known more commonly as telephone numbers) for addressing. This standard is herein incorporated by reference.

As background to the above-mentioned SMS texting, SMS currently uses short message peer-to-peer protocol (SMPP), which is currently the telecommunications industry protocol for exchanging SMS messages between SMS peer entities, such as short message service centers. It is often used to allow third parties (e.g. value-added service providers like news organizations) to submit messages, often in bulk. The protocol is based on pairs of request/response PDUs (protocol data units, or packets) exchanged over OSI layer 4 (TCP/IP session or X.25 SVC3) connections. PDUs are binary encoded for efficiency. Currently, the most commonly used versions of SMPP are v3.3, the most widely supported standard, and v3.4, which adds transceiver support (single connections that can send and receive messages). Data exchange may be synchronous, where each peer waits for a response for each PDU being sent, and asynchronous, where receiving and transmitting go in independent threads with the use of buffers and timers. The latest version of SMPP is v5.0. The standards and technical details defined therein are herein incorporated by reference.

As further background to SIP, SIP is an Internet Engineering Task Force (IETF) standard protocol for initiating an interactive user session that involves multimedia elements such text, video, voice, chat, gaming, and virtual reality. Like HTTP or SMTP, SIP works in the Application layer of the Open Systems Interconnection (OSI) communications model. The Application layer is the level responsible for ensuring that communication is possible. SIP can establish multimedia sessions or Internet telephony calls, and modify, or terminate calls. SIP is a request-response protocol, dealing with requests from clients and responses from servers. Participants are identified by SIP URLs. Requests can be sent through any transport protocol, such as UDP, SCTP, or TCP. In the embodiments defined herein, SIP is used to determine the end system to be used for the session, the communication media and media parameters, and the called party's desire to engage in the communication. Once these are assured, SIP can be set to establish call parameters at either end of the communication, and can handles call transfer and termination. The Session Initiation Protocol is specified in IETF Request for Comments [RFC] 2543. This standard is herein incorporated by reference.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The invention can also be embodied as computer readable code on a computer readable medium. The computer readable medium is any data storage device that can store data which can be thereafter read by a computer system. The computer readable medium may also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The above described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A computer implemented method for establishing a phone call between parties, comprising:
receiving a text message at a server;
processing the text message at the server to identify a type of call requested in the text message and the parties to connect;
initiating two or more internet-based calls from the server so as to establish phone connections to each of the parties; and
bridging the phone connections to establish the phone call between the parties.

2. A computer implemented method for establishing a phone call between parties as recited in claim 1, wherein the type of call is between two phone numbers, or between more than two phone numbers.

3. A computer implemented method for establishing a phone call between parties as recited in claim 1, wherein the type of call requested in the text message can for establishing the phone call between phone numbers that do not correspond to an originator of the text message.

4. A computer implemented method for establishing a phone call between parties as recited in claim 1, wherein phone connections are established after the server forwards invites to each of the parties and confirmation of the invites is established when the parties answer phones that receive the invites.

5. A computer implemented method for establishing a phone call between parties as recited in claim 1, wherein bridging the phone connections includes negotiation of IP addresses and ports of the phone connections.

6. A computer implemented method for establishing a phone call between parties as recited in claim 1, wherein initiating internet-based calls from the server includes processing internet call handling protocols to establish IP addresses and ports for the calls and brokering internet to non-internet phone connections.

7. A computer implemented method for establishing a phone call between parties as recited in claim 6, wherein non-internet phone connections include Public Switched Telephone Network (PSTN) connections.

8. A method for establishing a phone call between a caller and a recipient, the method comprising:
(a) receiving a text message from a mobile device, the text message identifying a type of call action and a recipient phone number for the recipient;
(b) processing the text message to identify the recipient phone number and a receiving phone number of the caller;
(c) initiating a call request to establish a caller connection for the caller followed by a recipient connection for the recipient; and
(d) establishing a bridge between the caller connection and the recipient connection to enable voice data to travel for the call action between the caller and the recipient.

9. A method for establishing a phone call between a caller and a recipient as recited in claim 8, wherein after performing the initiating of the call request, the method further comprises,
(i) forwarding a call invite to the receiving phone number of the caller;
(ii) detecting acceptance of the call invite at the receiving phone number of the caller to establish the caller connection;
(iii) forwarding a call invite to the recipient phone number; and
(iv) detecting acceptance of the call invite at the recipient phone number to establish the recipient connection; and

10. A method for establishing a phone call between a caller and a recipient as recited in claim 8, wherein the receiving phone number of the caller is either a phone number of the mobile device from which the text message was sent or another identified phone number, as identified in the text message.

11. A method for establishing a phone call between a caller and a recipient as recited in claim 8, wherein when the phone number of the caller is another identified phone number, the other identified phone number is bridged with the recipient phone number.

12. A method for establishing a phone call between a caller and a recipient as recited in claim 9, further comprising:
if the call action is a conference call, processing (b)-(c) such that two or more phone numbers are invited and bridged.

13. A method for establishing a phone call between a caller and a recipient as recited in claim 12, wherein (i)-(iv) is processed to enable bridging of the two or more phone numbers that are invited when the call action is a conference call.

14. A method for establishing a phone call between a caller and a recipient as recited in claim 8, wherein the text message is formatted as a short message service (SMS) message.

15. A method for establishing a phone call between a caller and a recipient as recited in claim 8, wherein a shortcode is used to forward the SMS message to a bridge establishing provider, the bridge establishing provider charged with establishing the bridge between the caller connection and the recipient connection.

16. A method for establishing a phone call between a caller and a recipient as recited in claim 15, wherein the shortcode is directed toward an SMS gateway of the bridge establishing provider, and the call request is initiated by the SMS gateway that forwards the call request to a call initiation process (CIP) server that is capable of creating, modifying, and terminating call sessions.

17. A method for establishing a phone call between a caller and a recipient as recited in claim 8, wherein establishing the bridge includes,
identification of IP address and Port data of the caller connection and the recipient connection; and
presenting the IP address and Port data of the recipient connection to the caller connection, such negotiation between the caller connection and the recipient connection defines the bridge to enable the voice communication.

18. A method for establishing a phone call between an originator and a recipient, comprising:
(a) receiving a text message from a mobile device, the text message identifying a type of call action and a recipient phone number for the recipient;
(b) processing the text message to identify the recipient phone number and a receiving phone number of the originator;
(c) initiating a call request, the call request causing,
(i) forwarding a call invite to the receiving phone number of the originator;
(ii) detecting acceptance of the call invite at the receiving phone number of the originator to establish an originator connection;
(iii) forwarding a call invite to the recipient phone number; and
(iv) detecting acceptance of the call invite at the recipient phone number to establish a recipient connection; and
(d) establishing a bridge between the originator connection and the recipient connection to enable voice data to travel for the call action between the originator and the recipient.

19. A method for establishing a phone call between an originator and a recipient as recited in claim 18, wherein the text message is formatted as a short message service (SMS) message.

20. A method for establishing a phone call between an originator and a recipient as recited in claim 19, wherein a shortcode is used to forward the SMS message to a bridge establishing provider, the bridge establishing provider charged with establishing the bridge between the originator connection and the recipient connection.

21. A method for establishing a phone call between an originator and a recipient as recited in claim 20, wherein the shortcode is directed toward an SMS gateway of the bridge establishing provider, and the call request is initiated by the SMS gateway that forwards the call request to a call initiation process (CIP) server that is capable of creating, modifying, and terminating call sessions.

22. A method for establishing a phone call between an originator and a recipient as recited in claim 21, wherein the CIP is an application-layer control and signaling protocol.

23. A method for establishing a phone call between an originator and a recipient as recited in claim 22, wherein CIP uses protocols defined by one of Session Initiation Protocol (SIP), Extensible Messaging and Presence Protocol (XMPP), and Interdomain access control (IAC).

24. A method for establishing a phone call between an originator and a recipient as recited in claim 18, wherein the receiving phone number of the originator is either a phone number of the mobile device from which the text message was sent or another identified phone number, as identified in the text message.

25. A computing device implemented method for establishing a phone call between a caller and a recipient or a caller and recipients, the method comprising:
(a) receiving a text message from a text capable communication device, the text message identifying a type of call action and a recipient phone number for the recipient;
(b) processing the text message to identify the recipient phone number and a receiving phone number of the caller, the processing determining a time and date for the phone call;
(c) at a stated time and date, initiating a call request to establish a caller connection for the caller followed by a recipient connection for the recipient; and
(d) establishing a bridge between the caller connection and the recipient connection to enable voice data to travel for the call action between the caller and the recipient;
wherein the receiving phone number of the caller is either a phone number at a location from which the text message was sent or another identified phone number, as identified in the text message.

26-27. (canceled)
